(19) United States
(12) Patent Application Publication
(10) Pub. No.: US 2008/0220260 A1
(43) Pub. Date: Sep. 11, 2008

(54) Light Emitting Device With A Ceramic Sialon Material

(75) Inventors: Peter Schmidt, Aachen (DE); Jorg Meyer, Aachen (DE); Wolfgang Busselt, Roetgen (DE); Hans-Helmut Bechtel, Roetgen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/088,439

(22) PCT Filed: Sep. 26, 2006
(86) PCT No.: PCT/IB2006/053490

§ 371 Date: Mar. 28, 2008

(30) Foreign Application Priority Data
Sep. 30, 2005 (EP) 05109044.7

(51) Int. Cl. B32B 17/00; C04B 35/64

(52) U.S. Cl. 428/426; 264/683

(57) ABSTRACT

The invention relates to a light emitting device, especially a LED comprising a SiAION material with a transparency of ≧10% to ≦85% for light in the wavelength range from ≧550 nm to ≦1000 nm.

### FIELD OF THE INVENTION

The present invention is directed to light emitting devices, especially to the field of LEDs

### BACKGROUND OF THE INVENTION

Phosphors comprising silicates, phosphates (for example, apatite) and aluminates as host materials, with transition metals or rare earth metals added as activating materials to the host materials, are widely known. As blue LEDs, in particular, have become practical in recent years, the development of white light sources utilizing such blue LEDs is being energetically pursued. As white LEDs are expected to have lower power consumption and longer usable lives than existing white light sources, development is progressing toward their applications in backlights of liquid crystal panels, indoor lighting fixtures, backlights of automobile panels, light sources in projection devices and the like.

In current LEDs alpha-SiAlONes are more and more widely used as emitter materials due to their excellent material and thermal properties. However, it has so far been a problem that the emission spectrum as well as the thermal luminescence quenching properties are for some applications yet to be improved especially when the LEDs are to be used in automotive applications such as backlights of cars.

### SUMMARY OF THE INVENTION

It is an object of the present invention to provide a light emitting device which comprises a SiAlON-material with improved characteristics.

This object is solved by a light emitting device according to claim 1 of the present invention. Accordingly, a light emitting device, especially a LED is provided, comprising a SiAlON material with a transparency for normal incidence in air of ≧10% to ≦85% for light in the wavelength range from ≧550 nm to ≦1000 nm.

When using such a SiAlON material, the features of the light emitting device may in most applications greatly be improved (as will for some applications be described later on).

Preferably, the transparency for normal incidence is in air of ≧20% to ≦80% for light in the wavelength range from ≧550 nm to ≦1000 nm, more preferred ≧30% to ≦75% and most preferred >40% to <70% for a light in the wavelength range from ≧550 nm to ≦1000 nm.

Preferably, the transparency for normal incidence is in air of ≧10% to ≦85%, more preferred ≧20% to ≦80% and most preferred ≧30% to ≦75% for light in the wavelength range from ≧650 nm to ≦800 nm.

The term “SiAlON-material” comprises and/or includes especially the following materials:

Mₓ^{v+}Si₁₂₋₍ₘ₊ₙ₎Alₘ₊ₙOₙN₁₆₋ₙ,

with x=m/v and M being a metal, preferably selected out of the group comprising Li, Mg, Ca, Y, Sc, Ce, Pr, Nf, Sm, Eu, Gd, Tb, Dy, Ho, Er, Tm, Yb, Lu or mixtures thereof

as well as a mixture of these materials with additives which may be added during ceramic processing. These additives may be incorporated fully or in part into the final material, which then may also be a composite of several chemically different species (SiAlON crystallites embedded into a glassy matrix of slightly different composition) and particularly include such species known to the art as fluxes. Suitable fluxes include alkaline earth—or alkaline—metal oxides and fluorides, SiO₂ and the like.

The term “transparency” in the sense of the present invention means especially that ≧10% preferably ≧20%, more preferred ≧30%, most preferred ≧40% and ≦85% of the incident light of a wavelength, which cannot be absorbed by the material, is transmitted through the sample for normal incidence in air (at an arbitrary angle). This wavelength is preferably in the range of ≧550 nm and ≦1000 nm.

According to a preferred embodiment of the present invention, the SiAlON material has an emission band in the yellow-amber visible wavelength range with a maximum of ≧570 nm to ≦640 nm. This allows to build up a light emitting device with improved characteristics. Preferably the SiAlON material has an emission band in the yellow-amber visible light wavelength area with a maximum of ≧580 nm to ≦620 nm, more preferred of ≧590 nm to ≦610 nm.

According to a preferred embodiment of the present invention, the SiAlON material has an emission band in the yellow-amber visible light wavelength area with a half-width of ≧50 nm to ≦180 nm. This results in a sharp emission band, which allows to further improve the light emitting device. Preferably the SiAlON material has an emission band in the yellow-amber visible light wavelength area with a half-width of ≧60 nm to ≦130 nm.

According to a preferred embodiment of the present invention, the SiAlON material has ≧95% to ≦100% of the theoretical density. By doing so, the SiAlON material shows greatly improved mechanical and optical characteristics compared to materials with less density. Preferably, the SiAlON material has ≧97% to ≦100% of the theoretical density, more preferred ≧98% to ≦100%

According to a preferred embodiment of the present invention, the SiAlON material is a polycrystalline material.

The term “polycrystalline material” in the sense of the present invention means especially a material with a volume density larger than 90 percent of the main constituent, consisting of more than 80 percent of single crystal domains, with each domain being larger than 0.5 μm in diameter and having different crystallographic orientations. The single crystal domains may be connected by amorphous or glassy material or by additional crystalline constituents.

According to a preferred embodiment of the present invention, the SiAlON material is a ceramic material.

The term “ceramic material” in the sense of the present invention means especially a crystalline or polycrystalline compact material or composite material with a controlled amount of pores or which is porefree.

Preferably the thickness of the ceramic material D is 30 μm≦D≦5000 μm, preferred 60 μm≦D≦2000 μm most preferred 80 μm≦D≦1000 μm. This has shown in practiced to best suitable.

According to a preferred embodiment of the present invention, the shift of the maximum and/or the half-width in the emission band in the yellow-amber visible light wavelength area of the SiAlON material is ≧0 nm to ≦20 nm over the whole temperature range from ≧50° C. to ≦150° C. By doing so, the light emitting device will show a constant behaviour during performance e.g. when used in a car.

Preferably the shift of the maximum and/or the half-width in the emission band in the yellow-amber visible light wavelength area of the SiAlON material is ≧0 nm to ≦20 nm over the whole temperature range from ≧0° C. to ≦200° C., and most preferred from ≧−40° C. to ≦250° C.

Preferably the shift of the maximum and/or the half-width in the emission band in the yellow-amber visible light wavelength area of the SiAlON material is ≧2 nm to ≦18 nm over the whole temperature range from ≧550° C. to ≦150° C., more preferred ≧0° C. to ≦200° C., and most preferred from ≧−40° C. to ≦250° C. Preferably the shift of the maximum and/or the half-width in the emission band in the yellow-amber visible light wavelength area of the SiAlON material is ≧4 nm to ≦15 nm over the whole temperature range from ≧50° C. to ≦150° C., more preferred ≧0° C. to ≦200° C., and most preferred from ≧−40° C. to ≦250° C.

According to a preferred embodiment of the present invention, the SiAlON material comprises as a major constituent a Europium doped Ca-α-SiAlON according to the general formula (Ca₁₋ₓ,Euₓ)_{m/2}Si_{12-(m+n)Al}ₘ₊ₙOₙN₁₆₋ₙ with 2≦m≦4, 0.001≦n≦2 and 0.01≦x≦0.20. More preferred are compositions with 2.5≦m≦3.5, 0.01≦n≦1 and 0.015≦x≦0.15. Most preferred are compositions with 2.75≦m≦3.25, 0.05≦n≦0.5 and 0.015≦x≦0.1.

It has been found that in most applications low oxygen content and doping levels lead to increased luminescence performance of the materials.

The term “major constituent” means especially that ≧95%, preferably ≧97% and most preferred ≧99% of the SiAlON material consists out of this material. However, in some applications, trace amounts of additives may also be present in the bulk compositions. These additives particularly include such species known to the art as fluxes. Suitable fluxes include alkaline earth—or alkaline—metal oxides and fluorides, SiO₂ and the like and mixtures thereof.

According to a preferred embodiment of the present invention, the glass phase ratio of the SiAlON material is ≧2% to ≦5%, more preferred ≧3% to ≦4%. It has been shown in practice that materials with such a glass phase ratio show the improved characteristics, which are advantageous and desired for the present invention.

The term “glass phase” in the sense of the present invention means especially non-crystalline grain boundary phases, which may be detected by scanning electron microscopy or transmission electron microscopy.

According to a preferred embodiment of the present invention, the surface roughness RMS (disruption of the planarity of a surface; measured as the geometric mean of the difference between highest and deepest surface features) of the surface(s) of the SiAlON material is ≧0.001 μm and ≦100 μm. According to an embodiment of the present invention, the surface roughness of the surface(s) of the SiAlON material is ≧0.01 μm and ≦10 μm, according to an embodiment of the present invention ≧0.1 μm and ≦5 μm, according to an embodiment of the present invention ≧0.15 μm and ≦3 μm, and according to an embodiment of the present invention ≧0.2 μm and ≦2 μm.

According to a preferred embodiment of the present invention, the specific surface area of the SiAlON material structure is ≧10⁻⁷ m²/g and ≦1 m²/g.

The present invention furthermore relates to a method of producing a SiAlON material for a light emitting device according to the present invention comprising a sintering step.

The term “sintering step” in the sense of the present invention means especially densification of a precursor powder under the influence of heat, which may be combined with the application of uniaxial or isostatic pressure, without reaching the liquid state of the main consitituents of the sintered material.

According to a preferred embodiment of the present invention, the sintering step is pressureless, preferably in reducing or inert atmosphere.

According to a preferred embodiment of the present invention, the method furthermore comprises the step of pressing the SiAlON precursor material to ≧50% to ≦70%, preferably ≧55% to ≦60%, of its theoretical density before sintering. It has been shown in practice that this improves the sintering steps for most SiAlON materials as described with the present invention.

According to a preferred embodiment of the present invention, the method of producing SiAlON material for a light emitting device according to the present invention comprises the following steps:

(a) Mixing the precursor materials for the SiAlON material
(b) optional firing of the precursor materials, preferably at a temperature of ≧1300° C. to ≦1700° C. to remove volatile materials (such as CO₂ in case carbonates are used)
(c) optional grinding and washing
(d) a first pressing step, preferably a unixial pressing step at ≧110 kN using a suitable powder compacting tool with a mould in the desired shape (e.g. rod- or pellet-shape) and/or a cold isostatic pressing step preferably at ≧3000 bar to ≦3500 bar.
(e) a pressureless sintering step at ≧1500° C. to ≦2200° C.
(f) a hot pressing step, preferably a hot isostatic pressing step preferably at ≧100 bar to ≦2500 bar and preferably at a temperature of ≧1500° C. to ≦2000° C. and/or a hot uniaxial pressing step preferably at ≧100 bar to ≦2500 bar and preferably at a temperature of ≧1500° C. to ≦2000° C.
(g) optionally a post annealing step at >1000° C. to <1700° C. in inert atmosphere or air.

According to this method, for most desired material compositions this production method has produced the best SiAlON materials as used in the present invention.

A light emitting device according to the present invention as well as a SiAlON material as produced with the present method may be of use in a broad variety of systems and/or applications, amongst them one or more of the following:

Office lighting systems

household application systems

shop lighting systems,

home lighting systems,

accent lighting systems,

spot lighting systems,

theater lighting systems,

fiber-optics application systems,

projection systems,

self-lit display systems,

pixelated display systems,

segmented display systems,

warning sign systems,

medical lighting application systems,

indicator sign systems, and

decorative lighting systems

portable systems

automotive applications

green house lighting systems

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

### BRIEF DESCRIPTION OF THE DRAWINGS

Additional details, characteristics and advantages of the object of the invention are disclosed in the subclaims, the figures and the following description of the respective figures and examples, which—in an exemplary fashion—show a preferred embodiment of a SiAlON-material for use in a light emitting device according to the invention.

FIG. 1 shows an emission spectra of an LED of SiAlON material according to Example I of the present invention at 20° C. and 100° C. ambient temperature.

FIG. 2 shows an X-ray diffractogram of the ceramic precursor powder after firing at 1500° C.

FIG. 3 shows an X-ray diffractogram of the ceramic pellet after firing at 1700° C.

### EXAMPLE I

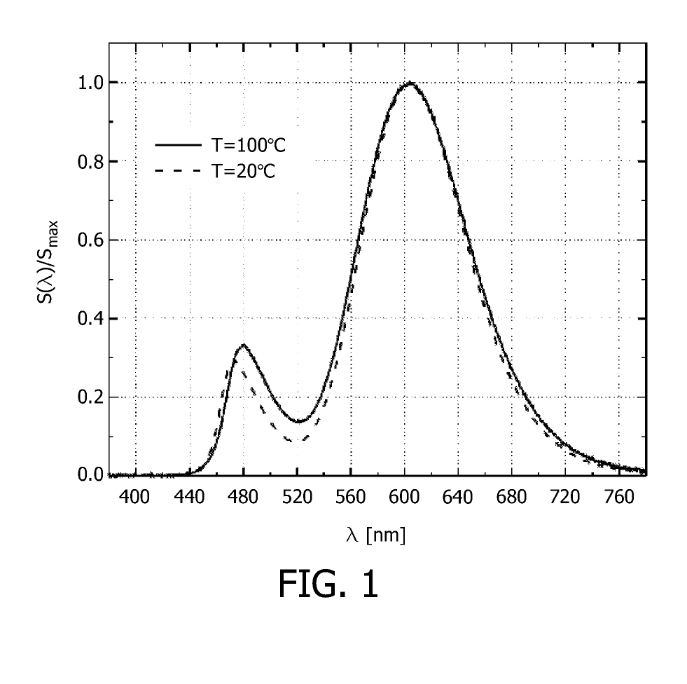

The FIGS. 1 to 3 refer to Ca_{0.75}Si_{8.625}Al_{3.375}O_{1.375}N_{14.625}:Eu_{0.25} (Example I) which was produced as follows:

Ca_{0.75}Si_{8.625}Al_{3.375}O_{1.375}N_{14.625}:Eu_{0.25} was synthesized from 0.751 g CaCO₃ (Alfa Aesar, Karlsruhe, Germany), 1.383 g AlN (Nanoamor, Los Alamos, N. Mex., USA), amorphous 4.234 g Si₃N₄ (Alfa Aesar) and 440 mg Eu₂O₃ (Alfa Aesar). The powders were mixed in a porcelain mortar, filled into Molybdenum crucibles and fired for 4 h at 1500° C. in forming gas atmosphere. The powder was washed to remove impurities.

The obtained powder was milled and then compressed into pellets, cold isostatically pressed at 3200 bar and sintered at 1700° C. in forming gas atmosphere for 4 h. The resulting pellets displayed a closed porosity and are subsequently hot isostatically pressed at 2000 bar and 1750° C. to obtain dense ceramics with >99% of the theoretical density.

FIG. 1 shows an emission spectra of an LED of the SiAlON material according to Example I of the present invention at 20° C. and 100° C. ambient temperature. It can be clearly seen that the emission maximum of the SiAlON material is around 605 nm in both spectra and that the shift in half-width as well as in emission maximum for the SiAlON material according to the Example is <5 nm.

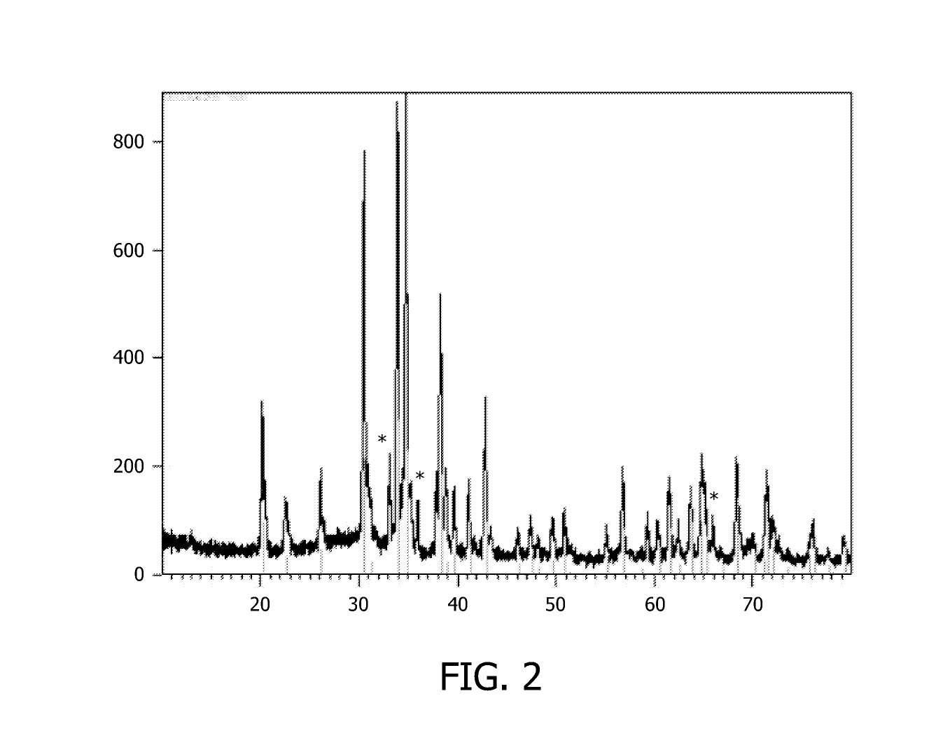

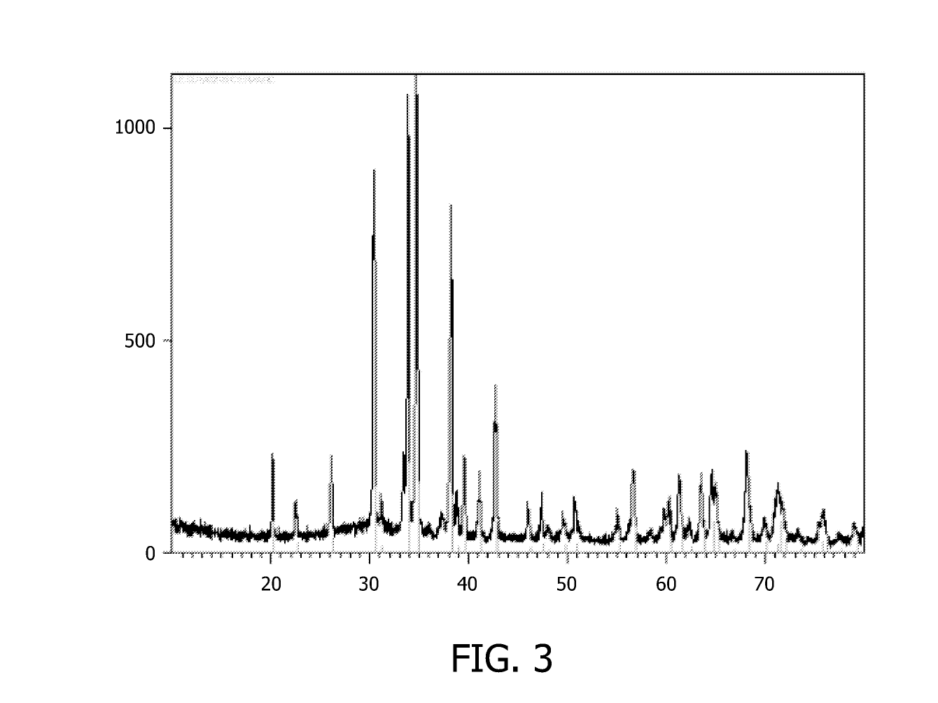

FIG. 2 shows a X-ray diffractogram of the ceramic precursor powder after firing at 1500° C., FIG. 3 shows a X-ray diffractogram of the ceramic pellet after firing at 1700° C. In FIG. 2 AlN is present as impurity, which results in several bands which are marked with asterisk (“*”), whereas the pellets after firing (FIG. 3) are essentially pure.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

1. Light emitting device, especially a LED comprising a SiAlON material with a transparency for normal incidence in air of ≧10% to ≦85% for light in the wavelength range from ≧550 nm to ≦1000 nm.

2. The light emitting device of claim 1, whereby the SiAlON material has an emission band in the yellow-amber visible range with a maximum wavelength of ≧570 nm to ≦640 nm.

3. The light emitting device of claim 1, whereby the SiAlON material has an emission band in the yellow-amber range with a half-width of ≧50 nm to ≦180 nm

4. The light emitting device of claim 1 whereby the SiAlON material has ≧95% to ≦100% of the theoretical density.

5. The light emitting device of claim 1 whereby the shift of the maximum and/or the half-width in the emission band in the yellow-amber visible range of the SiAlON material is ≧0 nm to ≦20 nm over the whole temperature range from ≧50° C. to ≦150° C.

6. The light emitting device of claim 1 whereby the SiAlON material comprises as a major constituent a Europium doped Ca-α-SiAlON according to the general formula (Ca₁₋ₓ,Euₓ)_{m/2}Si₁₂₋₍ₘ₊ₙ₎Alₘ₊ₙOₙN₁₆₋ₙ with 2≦m≦4, 0.001≦n≦2 and 0.01≦x≦0.20.

7. The light emitting device of claim 1 whereby the glass phase ratio of the SiAlON material is ≧2% to ≦5%.

8. A method of producing a SiAlON material for a light emitting device according to claim 1 comprising a sintering step.

9. The method according to claim 8, further comprising the step of pressing the SiAlON precursor material to ≧50% to ≦70% of its theoretical density before sintering.

10. A system comprising a light emitting device according to claim 1, the system being used in one or more of the following applications:
Office lighting systems
household application systems
shop lighting systems,
home lighting systems,
accent lighting systems,
spot lighting systems,
theater lighting systems,
fiber-optics application systems,
projection systems,
self-lit display systems,
pixelated display systems,
segmented display systems,
warning sign systems,
medical lighting application systems,
indicator sign systems, and
decorative lighting systems
portable systems
automotive applications
green house lighting systems
